(19) United States
(12) Patent Application Publication
(10) Pub. No.: US 2003/0072917 A1
(43) Pub. Date: Apr. 17, 2003

(54) Vacuum formed thermoplastic films and articles therefrom

(76) Inventor: Ewen Anthony Campbell, Winchester, VA (US)

Correspondence Address: Joe A. Powell, PolyOne Corporation, 33587 Walker Road, Avon Lake, OH, 44012, US

(21) Appl. No.: 09/975,700

(22) Filed: Oct. 11, 2001

(51) Int. Cl. B32B 1/00; B29C 51/10; B29C 51/14

(52) U.S. Cl. 428/141; 428/304.4; 264/553; 264/510; 264/511

(57) ABSTRACT

The present invention relates to vacuum forming thermoplastic films by using a porous female mold. The invention further relates to vacuum formed articles, such as automotive interior trim parts made by using the porous female mold.

### TECHNICAL FIELD

The present invention relates to a method of making shaped articles by vacuum forming thermoplastic films using a porous mold. Said mold made from a composition comprising a binder and spherical inorganic matrix particles. The invention further relates to shaped thermoplastic articles made by vacuum forming.

### BACKGROUND ART

Vacuum forming is a common process used to form thermoplastic parts for many applications including automotive interior trim parts. Automotive interior trim parts include instrument panels, door panels, consoles, sun visors and the like. These products are used in the passenger compartments of passenger cars, trucks, SUV's, buses and other mass transit vehicles. Recreational vehicles such as boats, motor homes and the like can also use these vacuum formed parts.

In recent years, the thermoplastic material of choice for these parts was flexible polyvinyl chloride (PVC) or acrylonitrile-butadiene-styrene copolymers/PVC alloys because of their excellent weatherability, low cost and ability to retain their embossed (textured) pattern after deep draw vacuum forming. When using PVC for these applications, the normal process was to first calender or extrude a sheet of the PVC and emboss a surface pattern on the freshly made sheet. For most applications, the embossing pattern used was one which resembled animal hide (leather) or fabric. The embossed PVC sheet would be heated and vacuum formed over a male mold with the embossed film surface on top. Flexible PVC, because of its rubbery nature and broad temperature softening range when heated, could be drawn down by vacuum over the mold and would retain most of its embossing pattern. The embossed or textured surface becomes the top surface of the part which is visible to the passengers inside the vehicle.

For some parts requiring a highly embossed pattern and having long and steep verticle sides, a slush or powder molding technique is used to make these parts. Slush or powder molding is normally more expensive than vacuum forming. In slush or powder molding, a female mold is used and a liquid polymer mixture, such as PVC plastisol or PVC powder, is introduced to the mold and gelled in place to create the part. When using a female mold for these molding processes, the desired embossing pattern is etched into the female mold. It is well understood by those skilled in the art that a mold shaped like the letter “n” would be a male mold, while a mold shaped like the letter “u” would be a female mold.

In recent years, the customers of these vacuum formed parts are requesting parts made of thermoplastic polyolefins (TPO) because of their light weight and recyclability with other plastics. TPO's have a more exact melting point than PVC and when a sheet of TPO is heated to vacuum form over a male mold, the TPO sheet tends to lose its embossing pattern, especially on the deep draw areas. The TPO becomes so soft, the embossing pattern smears and loses its embossed definition.

Once the thermoplastic sheet is formed to make the interior trim part, a layer of foam is added to give the part a soft feel. The foam can be a polyurethane foam, which is normally added after vacuum forming, or in some cases a polyolefin foam can be laminated to the embossed film before vacuum forming. A rigid structure layer is also added to the part by low pressure molding or injection molding (high pressure) or by thermoforming the film over a rigid substrate. The rigid structure layer is typically a rigid thermoplastic such as ABS or polypropylene.

It would be desirable to be able to vacuum form thermoplastics, particularly TPO's, using an inexpensive female mold with an ability to fully transfer a textured surface to the thermoplastic film.

Recent developments in the molding technology have provided molds, in particular in the field of deep drawing, consisting of porous materials with enhanced surface properties and improved air permeability replacing formerly used molds consisting of a non-porous, solid mold into which were provided with holes through which the air is withdrawn by suction. This technique has been proven to be deficient when it comes to transferring finely structured or smooth surfaces to the molded deep-drawn article.

U.S. Pat. No. 6,015,518 discloses a device comprising a coarsely porous shaped part, whose surface, at the point where the fluid flows through it, carries a finely porous surface layer and on the other surface areas fluid-impermeable closing means, which are interrupted by at least one duct connection opening. At least the coarsely porous shaped part and the finely porous surface layer are in the form of a plastic body through which passes a three-dimensional network of pores, which pass in finer but continuous manner from the shaped part into the surface layer and to the outer surface thereof. The fluid-impermeable closing means can be constructed as pore-free closing layer for the same plastic body or can be a separate part linked by suitable means with the plastic body. The coarsely porous shaped part, the finely porous surface layer and optionally the pore-free closing layer advantageously are made from the same cured plastic, in which are incorporated in the vicinity of the surface layer smaller particles, in the vicinity of the shaped part larger particles and in the vicinity of the closing layer no particles. The weight proportion of the particles in the surface layer and in the shaped part is higher than the weight proportion of the plastic and in the surface layer it is generally lower than in the shaped part. For the manufacture of the device various mixtures of particles and as yet uncured plastic are produced, said mixtures being superimposed in suitable molds, compacted (optionally individually) and cured together. Concerning the materials particularly suitable for the manufacture of the device according to '518 it is referred to European patent application publication 0486421. The material comprises a cured plastic, e.g. an epoxy-based plastic, in which are incorporated particles with a preferably irregular shape in such a way that the material has a continuous porosity in all directions. The particles are preferably of aluminum or an aluminum alloy, but can also be of another metal or a ceramic material.

U.S. Pat. No. 5,061,427 is directed to a mold body consisting of a mechanically workable, porous material, which allows providing complicated shapes without suffering a loss of quality of the deep drawn foil. The porous mold body is made by a method comprising the steps of shaping a mixture of metallic particles and resin into a uniformly porous homogeneous, unstratified block, wherein said metallic particles are of irregular shape and the size of said metallic particles is selected such than in said mixture particles of a size through the whole particle size range of 10 μm to 450 μm are provided; curing said resin; forming a shape determining gas permeable mold face surface on the unstratified block, said surface having a plurality of pores, by mechanically machining said shape determining mold face surface to a desired shape, wherein a porosity of said mold face surface remains intact during machining; and, covering a plurality of remaining surfaces of the block to make them gas impermeable.

WO publication 95/11744 describes a distributor element having a distributor body to distribute fluids as finely as possible and with low pressure loss. The distributing body is made of a material provided with pores connected to a channel system. The channel system is formed by the outer delimiting surfaces of clusters that in turn consists of particles, and connects the inlet surface with the outlet surface of the distributing body. Distributing surfaces that distribute the fluid in the distributing body before the fluid enters and flows through the distributing body are arranged in the distributing body.

U.S. Pat. No. 5,840,425 discloses a material, produced by forming clusters having a fine structure, each cluster comprising a plurality of particles of comparable size held together by a first binding agent and shaping said clusters into a cohesive structure with the aid of a second binding agent to fasten together a plurality of said clusters, thereby forming a coarser structured material, said material containing a first system of coarser structured channels and cavities extending between the clusters or being formed by the outer envelope of the clusters and a plurality of second systems of fine structured channels and cavities extending between the particles and within the clusters, said first coarse structured channel system and said second fine structured systems of channels being interconnected. According to the disclosure of the '425 patent the metal powder must have particles with a very irregular shape. The particle size is disclosed to be between 50 μm and 100 μm. Cluster formation takes place by a kneading and rubbing process, such as is carried out by bakers with dough. The disclosed material can be used for producing shaped articles, models, filters, distributors for distributing gases or liquids, mixers for mixing gases and/or liquids, storing means, fire/noise protection coverings, etc.

The state of the art porous articles consisting of a granular material and a plastic binder material suffer from the drawback that the pores clog along the surface where it is cut due to the smudging of the binder of the plastic material, and small particles of material from the art surface disintegrate resulting in a surface which is no longer perfectly smooth.

### SUMMARY OF THE INVENTION

It is a first object of the present invention to provide a process for female vacuum forming thermoplastic films.

It is a second object of the present invention to provide a process for producing articles such as automotive interior trim parts, using female vacuum forming.

It is a third object of the present invention to use a porous mold to vacuum form thermoplastic sheet such that the micro structure surface of the mold is exactly transferred to the thermoplastic sheet, even in deep drawn parts.

The above objects are accomplished by using a porous mold made from a composition comprising:

(i) a minor amount of a binder selected from the group consisting of organic polymers and alkali silicates: and

(ii) a major amount of spherical inorganic particles as the matrix.

### DETAILED DESCRIPTION OF THE INVENTION

The present invention requires a porous female mold which is capable of transferring the pattern or engraving of the mold onto the thermoplastic film which is drawn by vacuum down into the mold.

The porous mold used in the present invention is made from a composition comprising:

(i) a minor amount of a binder; and

(ii) a major amount of spherical inorganic particles (matrix particles).

According to the present invention, the binders used in the mold composition are selected from the group consisting of organic polymers and alkali silicates. The organic polymer binders are selected from the group consisting of thermoplastic polymers and cured polymers. In particular the binders are selected from the group consisting of:

(a) particulate thermoplastic polymers which are mixed with the matrix particles and which are subsequently sintered at a temperature above the melting point of the binder polymer,

(b) liquid polymer resins which are mixed with the matrix particles and which are subsequently cured by thermal or chemical curing, and

(c) aqueous solutions of sodium and/or potassium water-glasses which are mixed with the matrix particles and which are subsequently hardened by evaporation of water.

Polyetherether ketones (PEEK) are the preferred thermoplastic polymer (a). PEEK polymers having a heat distortion temperature of above 100° C., more preferably of at least about 150° C., and most preferably of at least about 175° C. are well known in the art. In general PEEK polymers possess an excellent solvent resistance and an outstanding thermal stability (PEEK-melts are stable for more than one hour at 400° C.). It may either be a homopolymer comprising repeating units or a copolymer comprising various repeating units. The phenylene groups of the said repeating units may contain lower alkyl groups, halogen groups, nitro groups, nitrile groups, amino groups, phenoxl groups, phenyl groups and/or byphenyl groups.

The PEEK used as the binder in the porous mold of the present invention may be obtained by known state of the art polymerization methods. As an example there may be mentioned a method of condensation polymerizing an aromatic dihalogen compound and a diphenol in the presence of an alkali salt. The said polymerization method as described in JP-B-57-22938, U.S. Pat. Nos. 4,113,699 and 4,320,224 and JP-A-54-90296. The disclosure of these references is incorporated herein by reference. The polymerization degree of PEEK used in the present invention is not particularly limited. The polymerization degree of PEEK is expressed as reduced viscosity obtained from measurements at 25° C. with an Ostwald viscometer of a 0.1 percent PEEK solution (PEEK weight/concentrated sulfuric acid volume), the solvent being concentrated sulfuric acid having a density of 1.83g/cm³. The measurement should be performed in the vicinity of 25° C. immediately after PEEK is dissolved in order to minimize the influence of sulfonation. The viscometer of an approximately two minute solvent efflux time is used in the measurement. The reduced viscosity of PEEK used in the present invention is ordinarily in the range of 0.5 to 2.5 dl/g. In order to obtain high mechanical strength of the resulting membrane, it is preferred that the reduced viscosity is in the range of 0.8 to 2.5 dl/g.

In an alternative the thermoplastic polymers (a) can be selected from the group consisting of polyvinylchloride (PVC), polypropylene (PP), polyethylene (PE), acrylonitrile-butadiene-styrene-copolymers (ABS), polycarbonates (PC), polymethylmethacrylate (PMMA), polyvinylidenfluoride (PVDF), and thermoplastic polyolefins (TPO). Preferably these thermoplastic polymers have a heat distortion temperature as defined above.

Epoxy resins are preferred as the liquid curable synthetic resin (b). Epoxy resins are prepolymers that contain on the average two or more epoxide groups per molecule. Their reaction with a variety of curing agents leads to cross-linked or thermoset plastics with excellent strength, toughness and chemical resistance. Suitable epoxy resins are known from the prior art and are commercially available. For instance, D.E.R._{®}, D.E.N._{®}, Tactix_{®}, Quartex_{®} supplied by Dow Chemical; Epon_{®}, Epikote_{®}, Eponol_{®}, Eponex_{®}, supplied by Shell; Araldite_{®}, Aracast_{®}, supplied by Ciba Geigy; Epi-Rz_{®} supplied by Celanese, Epotuf_{®} supplied by Reichold or Unox_{®} supplied by Union Carbide, Neukadur_{®}, Biresin_{®} and Ebalta LM_{®} can be used.

Important multifunctional curing agents for said epoxy resins include aliphatic and aromatic polyamines, dicarboxylic acid anhydrides, polyamide amines, aminoplasts and phenoplasts.

Further suitable liquid curable synthetic resin (b) are polyurethane (PU) resins, alkyd resins, unsaturated polyester (UP) resins, melamine resins, polyacrylate resins, vinylester resins and phenolic resins which are obtainable from condensation reactions of phenols with aldehydes or ketones.

The aqueous alkali silicate binder (c) is selected from the group consisting of sodium-water-glasses, potassium water-glasses and mixtures thereof. This binder (c), once hardened, is known for its superior thermal resistance.

After mixing an aqueous solution of water-glass and the matrix material the resulting premix is subsequently hardened by the evaporation of water. Suitable matrix particles have an average particle size within a certain predetermined range. The average particle size is referred to herein as the log-normal distribution D₅₀ median value. The D₅₀ median value is determined by using the sieve analysis procedure described in the American Society for Testing and Materials (ASTM) standard B214-92, entitled “Standard Test Method for Sieve Analysis of Granular Metal Powders” and the reporting procedure described in ASTM D1366-86 (reproved 1991), entitled “Standard Practice for Reporting Particle Size Characteristics of Pigments”. As used in this document, the matrix particles particle D₅₀ median value is determined by plotting the cumulative weight percentages versus the upper class size limits data, as shown in ASTM D-1366-86, and then determining the diameter (i.e. D₅₀) that corresponds to the fifty percent cumulative weight value.

In a preferred embodiment the matrix particles have a particle size of about 5 to about 80 μm, preferably about 5 to about 50 μm, most preferably about 25 to about 40 μm. In order to prevent clogging of the pores, at least about 80 wt.-%, preferably about 85 wt.-%, most preferably about 98 wt.-% of the matrix particles have an average particle size which does not deviate more than about 15%, preferably not more than about 10%, most preferably not more than about 5% from the average particle size.

Preferably the inorganic matrix particles are substantially free of dust having a particle size of less than about 5 μm, preferably less than about 4 μm. By “substantially free” there is meant that less than about 20 wt.-%, preferably less than about 15 wt.-% and most preferably less than about 10 wt.-% of the dust particles mentioned above are contained in the total of said matrix particles.

The inorganic matrix particles have a spherical shape, i.e., they are microspheres (micro-beads). A spherical shape leads to the least interaction (e.g., adhesion, friction, etc.) between the matrix particles and to the least clogging of the voids. The spherical shape of the matrix particles leads to flow-characteristics of the composition which is the basis for an excellent adaptation of fine surface structures of the master mold and renders the matrix particles capable to image the surface to be transferred.

Various matrix materials which fulfil the prerequisites in regard of shape and average particle size can be used. The materials of said matrix particles are selected from the group consisting of aluminum, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminum oxide, and magnesium oxide. Blends of particles of different materials can be used.

By a suitable selection of the matrix material the properties such as thermal and electrical conductivity, fluid permeability and/or mechanical, thermal and chemical stability of the mold materials can be controlled and predetermined.

The spherical matrix material is mixed with the binder polymer which sets after processing.

A method of making a porous mold for use in the invention comprises the steps of:

mechanically mixing:

a) a minor amount of a binder, and

b) a major amount of spherical inorganic matrix particles,

forming the mixture into the desired shape,

and exposing it for a time and at a temperature sufficient to solidify the mixture.

In particular, said method comprises the steps of:

mechanically mixing a major amount of spherical inorganic matrix particles with a minor amount of a binder selected from the group consisting of:

a) particulate organic thermoplastic polymers,

b) liquid organic polymer resins, and

c) aqueous solutions of alkali silicates

forming the mixture into the desired shape, and

treating the mixture for a time and at a temperature sufficient to

in case of (a), sinter the polymer, or

in case of (b ), cure the polymer, or

in case of (c), harden the mixture.

In case that a particulate thermoplastic organic polymer binder (a) is used the thermoplastic polymer binder and the spherical matrix material can be combined to form a premix with good shelf-life. Articles of various shapes, such as moldings, engraving or clamp tools can be formed from said premix. If a mold is to be formed from said premix the master mold is covered with the premix composition stamped, optionally followed by oscillating or vibrating the mixture. Subsequently the mold formed is sintered by a heat and pressure treatment and, thereafter, separated from the master mold. Concerning the particle size of the particulate thermoplastic organic binder polymer (a), the binder particles must have a particle size which is smaller or at least equal to the particle size of the spherical matrix particles.

In conjunction with the present invention the term “sintering” describes a controlled heat and pressure treatment by which the spherical matrix particles are covered with a thin layer of the molten binder polymer bonding the spherical particles together and maintaining the final shape of the shaped article. Dependent on the nature of the polymer binder the heat treatment takes between about 0.5 h and about 30 h, preferably between about 0.5 h and about 25 h.

The processing temperatures have to be above the melting point of the thermoplastic polymer. In general the processing temperature is between about 100° C. and about 400° C., preferably between about 100° C. and about 250° C.

The applied processing pressure depends on the shape and structure of the article to be produced, in general pressures up to 470 tons/cm² (1 ton=1,000 kg) can be used.

In an alternative method to produce the porous female mold, the treatment is carried out by gradually raising the temperature from about 20° C. to about 400° C., preferably about 20° C. to about 250° C. over a period of time between about 5 h and about 30 h, preferably between about 5 h and about 20 h.

The amount of binder is to be selected so as to not clog the cavities and pores in between the matrix particles. This is necessary in order to ensure the desired porosity of the shaped article. In view of this it is necessary to use an appropriate ratio of matrix particles to polymer binder. According to the invention the weight-ratio of matrix particles to polymer binder is chosen to be from about 100:10 to about 100:0.1, preferably from about 100:8 to about 100:1.0, most preferably from about 100:8 to about 100:3.5.

In case that a liquid, curable polymer binder (b) is used, for instance an epoxy resin, the inorganic matrix particles, the epoxy-resin and an appropriate amount of curing agent for the epoxy-resin are mixed immediately before forming the mold. In general the short pot life after addition of the curing agent requires an immediate processing of the composition. In contrast to the thermoplastic binder polymers (a) the non-thermal curable epoxy resin (b) can be applied if temperature sensitive master molds shall be transferred to a mold.

To avoid clogging of the pores of the obtained porous materials the mixture of the matrix material and binder polymer (b) should form a so-called “dry mixture”. This means that after thoroughly mixing the matrix particles and the polymer, a thin layer of the binder polymer covers each individual particle of the inorganic spherical matrix material. As already mentioned above in conjunction with binder polymer (a) the amount of the curable binder polymer is selected to be sufficient to cover the surface of the spherical particulates without filling and clogging the cavities between the micro-spheres.

A “dry mixture” consists of matrix particles and a binder polymer in a weight ratio of about 100:10 to about 100:0.1, preferably in a ratio of about 100:8 to about 100:1.0, most preferably in a weight ratio of about 100:8 to about 100:3.5.

The heat and pressure treatment is carried out depending on the nature of the epoxy binder polymer. Typically, the treatment is carried out between about 0.5 h and about 30 h, preferably between about 0.5 h and about 25 h.

In addition the temperature of the treatment has to be selected depending upon the epoxy binder polymer. When using a liquid chemical curing agent (b) the heat treating temperature is below the melting point of the polymer. Typically, the processing temperature is between about 20° C. and about 400° C., particularly between about 100° C. and about 250° C.

The applied processing pressure depends on the shape and structure of the mold to be produced, in general pressures up to 470 tons/cm² can be used.

In an alternative embodiment to produce the porous mold used in the present invention the treatment is carried out by gradually raising the temperature from about 20° C. to about 400° C., preferably about 20° C. to about 250° C. over a period of time between about 5 h and about 30 h, preferably between about 5 h and about 20 h.

In case that an aqueous solution of alkali silicates, for instance, sodium and/or potassium water-glasses (c) is used, the inorganic matrix particles and the aqueous water-glass are mixed before forming the mold. In contrast to the thermoplastic polymer binder (a) and to the curable epoxy resin (b), molding tools which are manufactured by use of water-glass (c) have a superior heat stability and show heat distortion temperatures above 800° C. The molding tools comprising hardened alkali silicates as the binder can be utilized for molding of low melting metals and metal alloys as well as forming the automotive interior trim parts of this invention.

To avoid clogging of the pores of the obtained porous materials the mixture of the matrix material and alkali silicates such as water-glass (c) should form a so-called “dry mixture”. This means that after thoroughly mixing the matrix particles and the water-glass a thin layer of the water-glass covers each individual particle of the inorganic spherical matrix material. As already mentioned above in conjunction with binder polymers (a) and (b) the amount of the alkali silicate binder is selected to be sufficient to cover the surface of the spherical particulates without filling and clogging the cavities between the micro-spheres.

A “dry mixture” consists of matrix particles and the alkali silicate in a weight ratio of about 100:10 to about 100:0.1, preferably in a ratio of about 100:8 to about 100:1.0, most preferably in a weight ratio of about 100:8 to about 100:3.5. The weight of the alkali silicate being determined on the weight of the dry alkali silicate.

The heat and pressure treatment is carried out between about 0.5 h and about 30 h, preferably between about 0.5 h and about 25 h.

The processing temperature is between about 20° C. and about 900° C., particularly between about 100° C. and about 400° C.

The applied processing pressure depends on the shape and structure of the mold to be produced, in general pressures up to 470 tons/cm² can be used.

In an alternative method to produce the porous mold used in the present invention the treatment is carried out by gradually raising the temperature from about 20° C. to about 900° C., preferably about 20° C. to about 250° C. over a period of time between about 5 h and about 30 h, preferably between about 5 h and about 20 h.

When making the porous shaped mold for use in this invention from the abovementioned compositions the pore-volume may additionally be influenced by a chemical foaming agent which may be used to enlarge the cavities and pores between the matrix particle spheres. Enlarging the pore-size leads to an increased fluid-permeability, such as air-permeability of the obtained porous mold. Chemical foaming agents which may be used for said purpose are selected from NH₄HCO₃ and Ca(H₂PO₄)₂ in combination with traces of water. Preferably the chemical foaming agent is present in an amount of about 0.1 to about 2.0 wt.-%, most preferably of about 0.1 to about 1.0 wt.-%, based on the total amount of the composition.

The porous mold used in this invention has (micro-) pores evenly distributed over the surface and throughout the mold. This permits the fluid to evenly flow through the entire surface of the porous mold. This is advantageous in that, in case of using the mold in a deep-drawing method, the film to be deep-drawn is evenly adhered to the mold surface by suction and simultaneously fixed to the entire surface allowing the contours and micro-contours (topography) of the mold-surface to transfer to/to impress on the article to be deep-drawn, such as a plastic film, without any loss of quality.

In accordance with the present invention the above-described porous mold has a structured, preferably a micro-structured surface. If said porous mold is used as a molding tool said structure may be transferred to/impressed on a work-piece, for instance, a vacuum formed article. The surface structure of the mold is perfectly transferred to the plastic, thus achieving an extremely detailed definition to the minutest detail.

A mold having a structured surface or a finer-structured surface having a micro-topography may be formed using the composition described above by impressing thereon a structured master-mold.

The mold is formed from a master mold or from a negative imprint of the original workpiece, respectively. Typically, the method comprises the following steps:

i. Providing the master mold with a separating means;

ii. Laminating those parts of the mold surface which will not image the later shape-producing surface of the mold to be produced (this step may also be made at the end);

iii. Embedding of pneumatic or hydraulic conduits, inserts and similar which are to be formed directly into the porous mold into the master mold;

iv. Obtaining an optimal mixing of the mixture consisting of matrix particles and binder;

v. Filling the mixture into the master mold;

vi. Stamping and oscillating/vibrating the mixture filled layer-by-layer into the master mold;

vii. Leaving the mold inside of the master mold to set and thereafter conducting a pressure and heat treatment depending on the molding composition which has been used;

viii. Removing the master mold from the mold;

ix. Removing the separating agent by a washing or grinding and finally, an annealing for reaching an optimum hardness and/or strength;

x. Covering the outer surfaces of the mold with the exception of its structure transferring/impressing surface with a surface layer, which seals the pores. In the sealing layer opening can be provided for the connection of a duct.

In this context it shall be noted specifically that because the mold can be processed mechanically, it is possible to provide for ducts for generating positive pressure or reduced pressure in the mold also at a later stage.

Alternatively, by means of the production steps set forth above a porous form body block of arbitrary shape and surface structure can be made by machining such as drilling, milling, rotary forming and grinding, engraving, impressing or polishing, etc.

The manufacturer of the mold has various alternatives to modify or repair the tool without it suffering from quality. It is evident that by such a procedure it is possible to produce tools for molds at low costs.

The mold is capable of conducting a fluid, such as a gas, between a space and duct comprising a porous shaped, part made of the composition as described above, whose surface is porous at the point where the fluid flows through, and the other surface areas are provided with a fluid-impermeable closing means (seal), which are interrupted by at least one duct connection opening.

Again, the surface of the mold, at the point where the fluid flows through may be structured or textured and therefore may be used to transfer/impress its topography/structure to a thermoplastic film.

In conjunction with the present invention, said fluid may be a liquid as well as a gas. Typically, the gas is air or nitrogen.

A further embodiment of the invention is directed to a deep-drawing mold comprising a duct and a shaped porous mold as described above, wherein the surface of said shaped porous mold, at the point where the fluid flows through, is porous and the other surface areas are provided with a fluid-impermeable closing means, which are interrupted by at least one duct connection opening.

Lastly, in two embodiments the invention is directed to a method of deep drawing and to a method of engraving or embossing the surface of a plastic part, using a mold as described above. In which a surface structure from a mastermold is transferred to the device and thereof to a plastic work-piece, e.g., a plastic film, wherein the plastic film is positioned over the porous surface of the porous shaped mold and air is sucked out of the cavity formed between the plastic film and the porous mold by means of a suction device.

The molds described above may be used for forming thermoplastic objects such as films and foils, preferably plastic films and foils by deep-drawing and engraving and impressing techniques. Particularly, the porous molds have the ability of transferring microstructures of surfaces, such as hair-like fabric, or leather-like structures to plastic films and foils.

The following three examples are presented to show specific compositions of porous molds which can be used in this invention along with the mechanical properties of the resultant mold. The examples all utilize different binders and matrix particles.

### Examples

### Example 1

Properties of the molding material

| | |
|---|---|
| Binder Polymer | epoxy-Resin, curing Agent |
| Matrix particles | Copper (10 μm) |
| Matrix particles/Binder Polymer ratio | 100:8.3 parts by weight |

After 15 to 30 min of thoroughly mixing of the listed compounds using a barrel mixer a homogeneous composition was obtained. A mold has been made using the above mentioned composition.

Properties of the mold

| Colour | copper-colored | |
|---|---|---|
| Density [g/cm³] | 4.79 | DIN 16945 |
| Flexural strength [N/mm²] | 23.7 | ISO 178 |
| Flexural modulus [N/mm²] | 6960 | ISO 178 |
| Tensile strength [N/mm²] | 10.6 | ISO 527 |
| Compressive strength [N/mm²] | 54 | ISO 604 |
| Heat distortion temperature [° C.] | 189 | ISO R 75 Be |
| Shore hardness [D] | 83 | DIN 53505 |
| Electrical resistance [Ω/cm] | 0.5 | |
| Air permeability [Nm³/h] | 1.78 | ¹⁾ |
| Reduced pressure [bar] | −0.75 | |

¹⁾The air permeability was measured by a compressed air consumption measuring device according to DIN 1952 or DIN 53887. All measurements have been performed under standardized conditions (room temperature, atmospheric pressure).

### Example 2

Properties of the molding material

| | |
|---|---|
| Binder Polymer | Polyetheretherketone (PEEK) |
| Matrix particles | Aluminumhydroxid (10 μm) |
| Matrix particles/Binder Polymer ratio | 100:3.125 parts by weight |

After 8 h of thoroughly mixing of the listed compounds using a barrel mixer a homogeneous composition was obtained. A mold has been made using the above-mentioned composition.

| Properties of the mold | | |
|---|---|---|
| Colour | White | |
| Density [g/cm³] | 2.2 | DIN 16945 |
| Flexural strength [N/mm²] | 48.7 | ISO 178 |
| Flexural modulus [N/mm²] | 12800 | ISO 178 |
| Impact strength [KJ/m²] | 3.4 | ISO 179 |
| Tensile strength [N/mm²] | 20.8 | ISO 527 |
| Compressive strength [N/mm²] | 74 | ISO 604 |
| Heat distortion temperature [° C.] | 340 | ISO R 75 Be |
| Shore hardness [D] | 87 | DIN 53505 |
| Air permeability [Nm³/h] | 1.75 | ¹⁾ |
| Reduced pressure [bar] | −0.9 | |

¹⁾The air permeability was measured by a compressed air consumption measuring device according to DIN 1952 or DIN 53887. All measurements have been performed under standardized conditions (room temperature, atmospheric pressure).

### Example 3

| Properties of the molding material | |
|---|---|
| Binder Polymer | Sodium water-glass |
| Matrix particles | Quartz (5-10 μm) |
| Matrix particles/Binder Polymer ratio | 100:0.25 parts by weight |

After 15 to 30 min of thoroughly mixing of the listed compounds using a barrel mixer a homogeneous composition was obtained. A mold has been made using the above-mentioned composition.

| Properties of the mold | | |
|---|---|---|
| Colour | Grey | |
| Density [g/cm³] | 2.5 | DIN 16945 |
| Flexural strength [N/mm²] | 23.7 | ISO 178 |
| Flexural modulus [N/mm²] | 24580 | ISO 178 |
| Impact strength [KJ/m²] | 2.4 | ISO 179 |
| Tensile strength [N/mm²] | 15.3 | ISO 527 |
| Compressive strength [N/mm²] | 84 | ISO 604 |
| Heat distortion temperature [° C.] | 900 | ISO R 75 Be |
| Rockwell hardness [HRA] | 87 | DIN 53505 |
| Air permeability [Nm³/h] | 1.88 | ¹⁾ |
| Reduced pressure [bar] | −0.72 | |

¹⁾The air permeability was measured by a compressed air consumption measuring device according to DIN 1952 or DIN 53887. All measurements have been performed under standardized conditions (room temperature, atmospheric pressure).

The thermoplastic films used to be vacuum formed with the porous mold described above can be any of the known thermoplastic polymer films. The most common of these thermoplastic films are made from polyvinylchloride (PVC), PVC/ABS alloys, thermoplastic polyolefins (TPO) such as elastomer modified polypropylene, and polyurethane. TPO's are polypropylene resins modified with elastomers to improve certain characteristics of the film such as vacuum formability and grain retention. The polypropylene resins may be modified by mixing them with an EPDM or EPR elastomer and cross linking the elastomer. The polypropylene may also be modified in the reactor as it is being produced. The end result of modifying the polypropylene is to add an amorphous rubber phase and reduce the crystalinity of the polypropylene. The films may be produced by calendering, extruding or casting. Extrusion and calendering are the two most common processes to manufacture the films. Since the films will be used in the female mold vacuum forming process, there is no need to emboss the final pattern on the film as is done for male mold vacuum forming. A light embossing can be used to minimize film blocking or sticking to itself in roll form.

It is customary to apply a painted or sprayed topcoat to the calendered or extruded films. The top coat is applied to give the uniform gloss finish required by the automotive companies and to give scratch and mar resistance to the film surface. The top coat is typically an acrylic, PVC, PVC/acrylic blend or polyurethane material. The film, in particular the TPO film, is essentially non-polar and has very low surface energy which does not provide good paint adhesion. The surface of the film is exposed to corona discharge, gas flame ionization or plasma treatment to achieve the desired surface energy for paint adhesion of the top coat. A primer can also be used before applying the top coat. The primer is particularly important when the film is a TPO.

The films may be produced as mono layer films or multiple layers can be applied together to create the film. If multiple layers are used, the layers can be the same material or different thermoplastic materials. One possible film could be a layer of solid TPO and a layer of polyolefin foam adhered to the solid TPO layer. The foam layer provides the soft feel when used in automotive interior trim such as door panels, instrument panels, consoles, sun visors and the like. The polyolefin foam can be cross linked polyethylene, cross linked polypropylene or blends of polyethylene and polypropylene cross linked.

In the process of this invention, the film is vacuum formed into the porous female mold. This is accomplished by heating the thermoplastic film to allow it to be soft enough to conform to the surface design of the mold. The softening temperature will vary depending on the composition of the film one desires to vacuum form. Determining the correct temperature is well understood by those skilled in the art. A vacuum is applied to the porous mold to remove the air trapped between the film and the mold. As the vacuum is applied, the film will be drawn down into the mold. The side of the film in contact with the mold will become the top surface or visible surface in the finished part as it is in its final use as an interior trim part.

The finished automotive interior trim part usually contains the top layer of embossed film, a soft layer of foam, such as polyurethane foam or polyolefin foam, and a rigid substrate of a rigid thermoplastic such as ABS, polycarbonate or polypropylene. The layers required and their thickness will depend on the particular application desired within the automobile, all as is well understood by those that supply the automotive markets.

A specific example of the thickness of the layers for an automotive instrument panel would be a top embossed layer of about 1.0 mm, if a compact sheet, and usually less thick if a polyolefin foam is used, for example from 0.5 mm to 0.75 mm when using a polyolefin foam. The polyolefin foam layer is about 1.0 to 4.0 mm thick. If a thermal barrier film layer is used it would be about 0.2 mm to 0.5 mm in thickness. The structural layer usually varies in thickness over the instrument panel depending on the tooling used and the desired strength in certain locations, all as is well understood by those skilled in the art.

The rigid structural layer is normally applied by low pressure or injection molding. Low pressure molding includes compression molding and injection compression molding. The vacuum formed part can be removed from the porous female mold and the part is transferred to a separate mold for the low pressure or injection molding of the structural layer. This is called a two-step process. An alternative method is to maintain the vacuum on the part formed in the porous female mold and mold the structural layer in a one-step process.

The finished part can be made by several processes. One example would be to calender or extrude a TPO compound to create a TPO sheet, laminate a cross-linked polyolefin foam sheet to the TPO sheet, followed by vacuum forming in a female porous mold. In some applications a polypropylene sheet is also laminated to the polyolefin foam layer to act as a thermal barrier in subsequent operations such as low pressure molding or injection molding. The thermal barrier layer protects the polyolefin foam layer. Low pressure or injection molding could then be used to place a rigid polypropylene structural layer onto the foam layer directly or onto the thermal barrier layer. This particular part described has the advantage of being very recyclable, since all the layers are polyolefins and any part trimmings or defective parts can be ground into small pieces and used as a recycle component in the rigid polypropylene substrate.

The foregoing description has been directed to particular embodiments of the invention in accordance with requirements of the Patent Statutes for the purposes of illustration and explanation. It will be apparent, however, to those skilled in the art, that many modifications, changes and variations in the claims embodiments will be possible without departing from the scope and spirit of the claimed invention. It is intended that the following claims be interpreted to embrace all such modifications and changes.

What is claimed is:

1. A process for vacuum forming thermoplastic film comprising:
a) providing a thermoplastic film;
b) heating said thermoplastic film to a temperature sufficient to allow the film to be drawn by vacuum into a female porous mold;
c) applying a vacuum through the surface of the porous mold on the air space between said thermoplastic film and said porous mold; and
d) conforming said thermoplastic film to said porous mold to allow said thermoplastic film to conform to the surface of said porous mold;
Wherein said female porous mold is made from a composition comprising
(i) a minor amount of a binder; and
(ii) a major amount of spherical inorganic matrix particles.

2. A process of claim 1 wherein the inorganic particles and the binder of said porous female mold composition is in a weight ratio of about 100:10 to about 100:0.1

3. A process of claim 2 comprising the inorganic matrix particles and the binder in a weight ratio of about 100:8 to about 100:1.0.

4. A process of claim 3 comprising the inorganic matrix particles and the binder in a weight ratio of about 100:8 to about 100:3.5.

5. A process of claim 1 wherein the binder for said porous mold is selected from the group consisting of organic polymers and alkali silicates.

6. A process of claim 5 wherein the organic polymer binder is selected from the group consisting of thermoplastic polymers.

7. A process of claim 5 wherein the organic polymer binder is selected from the group consisting of cured polymer.

8. A process of claim 5 wherein the alkali silicate is selected from the group consisting of sodium-water glasses, potassium-water-glasses and mixtures thereof.

9. A process of claim 6 wherein the thermoplastic organic binder polymer is selected from the group consisting of polyether-ether-ketones (PEEK), polyvinylchloride (PVC), polypropylene (PP), polyethylene (PE), acrylonitrile-butadiene-styrene-copolymers (ABS), polycarbonates (PC), polymethylmethacrylate (PMMA), polyvinylidenfluoride (PVDF) and thermoplastic polyolefins (TPO).

10. A process of claim 7 wherein the cured polymer is selected from the group consisting of epoxy resins, polyurethane (PU) resins, alkyd resins, unsaturated polyester (UP) resins, melamine resins, vinylester resins, acrylate resins and phenolic resins.

11. A process of claim 1 wherein the inorganic spherical matrix particles of said porous mold are made of a material selected from the group consisting of aluminum, copper, iron, steel, titanium, platinum, manganese, zinc, bronze and other metal alloys, coal, glass, ceramic, quartz, silica, silicon carbide, tungsten carbide, boron carbide, metakaolin, calcinated clay, chinese clay, calcium carbonate, barium sulfate, aluminum oxide, and magnesium oxide.

12. A process of claim 11 wherein the spherical inorganic matrix particles have a mean particle diameter of from about 5 to about 80 μm.

13. A process of claim 12 wherein the spherical inorganic matrix particles have a mean particle diameter of from about 10 to less than about 50 μm.

14. A process of claim 13 wherein the spherical inorganic matrix particles have a mean particle diameter of from about 25 to about 40 μm.

15. A process of claim 1 wherein at least about 80 wt-% of the spherical inorganic matrix particles of said porous mold have a particle size which does not deviate more than about 15% from the average particle size.

16. A process of claim 15 wherein at least about 85 wt-% of the spherical inorganic matrix particles have a particle size which does not deviate more than about 15% from the average particle size.

17. A process of claim 16 wherein at least about 98 wt-% of the spherical inorganic matrix particles have a particle size which does not deviate more than about 15% from the average particle size.

18. A process of claim 1 wherein said porous mold composition further comprises a chemical foaming agent.

19. A process of claim 18 wherein the chemical foaming agent is selected from the group consisting of NH₄HCO₃ and Ca(H₂PO₄)₂.

20. A process of claim 18 wherein the chemical foaming agent is present in an amount of from about 0.1 to about 2% by weight, based on the total amount of composition.

21. A process of claim 20 wherein the chemical foaming agent is present in an amount of from about 0.1 to about 1% by weight, based on the total amount of the composition.

22. A process of claim 1 wherein said thermoplastic film is a thermoplastic material selected from the group consisting of polyvinyl chloride (PVC), PVC/ABS alloys, polyurethane, and thermoplastic polyolefin (TPO).

23. A process of claim 22 wherein said thermoplastic film is a thermoplastic polyolefin.

24. A process of claim 23 wherein said thermoplastic polyolefin comprises elastomer modified polypropylene.

25. An interior automotive trim article comprising a thermoplastic top layer wherein said thermoplastic top layer has been vacuum formed in a female porous mold.

26. An article of claim 25 wherein said female porous mold is made from a composition comprising:
(i) a minor amount of a binder; and
(ii) a major amount of spherical inorganic matrix particles.

27. An article of claim 26 wherein said inorganic matrix particles and said binder of said porous mold composition are in a weight ratio of about 100:10 to about 100:0.1.

28. An article of claim 27 wherein said inorganic matrix particles and said binder of said porous mold composition are in a weight ratio of about 100:8 to about 100:1.0.

29. An article of claim 28 wherein said inorganic matrix particles and said binder of said porous mold composition are in a weight ratio of about 100:8 to about 100:3.5.

30. An article of claim 26 wherein said binder of said porous mold composition is selected from the group consisting of organic polymers and alkali silicates.

31. An article of claim 30 wherein said organic polymer binder is selected from the group consisting of thermoplastic polymers.

32. An article of claim 30 wherein said organic polymer binder is selected from the group consisting of cured polymer.

33. An article of claim 30 wherein said alkali silicates is selected from the group consisting of sodium-water glasses, potassium-water glasses, and mixtures thereof.

34. An article of claim 25 wherein said thermoplastic top layer is a thermoplastic material selected from the group consisting of polyvinyl chloride (PVC), PVC/ABS alloy, polyurethane, and thermoplastic polyolefin (TPO).

35. An article of claim 34 wherein said thermoplastic top layer is a thermoplastic polyolefin.

36. An article of claim 35 wherein said thermoplastic polyolefin comprises elastomer modified polypropylene.

37. An article of claim 25 wherein said thermoplastic top layer further comprises a coating material applied to the top surface, said coating material is selected from the group consisting of acrylic, PVC, PVC/acrylic blends, and polyurethane.

38. An interior automotive trim article comprising:
a) a textured top layer of thermoplastic film
b) an intermediate layer of foam in contact with said top layer, and
c) a rigid thermoplastic structure layer in contact with said foam layer, wherein said textured top layer is textured by vacuum forming into a porous female mold.

39. An article of claim 38 wherein said porous female mold is made from a composition comprising:
(i) a minor amount of a binder; and
(ii) a major amount of spherical inorganic matrix particles.

40. An article of claim 38 wherein said intermediate foam layer is selected from the group consisting of polyurethane foam and cross linked polyolefin foam.

41. An article of claim 38 wherein said textured top layer of thermoplastic film is a thermoplastic material selected from the group consisting of polyvinyl chloride (PVC), PVC/ABS alloy, polyurethane and thermoplastic polyolefin (TPO).

42. An article of claim 38 wherein said rigid thermoplastic structure layer is selected from the group consisting of acrylonitrile-butadiene-styrene copolymers, polycarbonate and polypropylene.

43. An article of claim 38 wherein said textured top layer is a thermoplastic polyolefin, said intermediate foam layer is a cross linked polyolefin foam, and said rigid thermoplastic structure layer is polypropylene.

44. An article of claim 38 wherein there is optionally a rigid thermoplastic thermal barrier film layer between said intermediate layer of foam and said structural layer.

45. An article of claim 38 wherein said article is selected from the group consisting of instrument panel, door panel, console and sun visor.

46. An article of claim 45 wherein said article is an instrument panel.

47. A process for producing a textured automotive interior trim article comprising:
(i) vacuum forming a two layer film comprising a top layer of a thermoplastic polyolefin film and a bottom layer of crosslinked polyolefin foam into a porous female mold having a textured surface;
(ii) molding onto said bottom layer of foam a thermoplastic structural layer comprising polypropylene; and
(iii) optionally, laminating a thermal barrier layer to said cross linked polyolefin foam prior to molding said structural layer.

48. A process of claim 47 wherein said porous female mold is made from a composition comprising:
(i) a minor amount of a binder; and
(ii) a major amount of spherical inorganic matrix particles.

49. A process of claim 47 wherein said structural layer is molded by low pressure molding.

50. A process of claim 47 wherein said structural layer is molded by injection molding.

51. A process of claim 47 wherein after vacuum forming said two layer film, or three layer film if the optional thermal barrier is used, in said porous female mold the application of vacuum is continued while the structural layer is molded in the same mold.

52. A process of claim 47 wherein after vacuum forming said two layer film, or three layer film if the optional thermal barrier is used, in said porous female mold, the vacuum formed two layer film is transferred to a second mold for the molding of the structural layer.
